(19) United States
(12) Patent Application Publication
(10) Pub. No.: US 2012/0217035 A1
(43) Pub. Date: Aug. 30, 2012

(54) Shielded insulated electric cable

(75) Inventors: Makoto Iwasaki, Hitachi (JP); Akinari Nakayama, Hitachinaka (JP)

(73) Assignee: HITACHI CABLE, LTD., Tokyo (JP)

(21) Appl. No.: 13/067,946

(22) Filed: Jul. 8, 2011

(30) Foreign Application Priority Data
Feb. 24, 2011 (JP) 2011-038431

(51) Int. Cl. H01B 7/17

(52) U.S. Cl. 174/102 C

(57) ABSTRACT

A shielded insulated electric cable includes an insulation layer that is in contact with a metal braid. The insulation layer includes a halogen-free cross-linked rubber that includes 100 parts by weight of a halogen-free rubber excluding a silicone rubber, and 1 to 20 parts by weight of a hindered phenol compound and a thioether compound.

The present application is based on Japanese Patent Application No. 2011-038431 filed on Feb. 24, 2011, the entire contents of which are incorporated herein by reference.

### BACKGROUND OF THE INVENTION

1. Field of the Invention

The invention relates to a shielded insulated electric cable including an insulation layer that is in contact with a metal braid as a shielding layer.

2. Description of the Related Art

FIG. 4 is a cross sectional view showing a conventional shielded insulated electric cable.

As shown in FIG. 4, a shielded insulated electric cable 40 is composed of an inner separator 42, an insulation layer 43, an intermediate separator 44, a metal braid 45, an outer separator 46 and sheath 47 which are sequentially formed on a conductor 41.

As a rubber material employed for the insulation layer 43, a halogen rubber including chloroprene rubber and fluoro-rubber or a halogen-free rubber such as ethylene-propylene rubber, acrylic rubber, butyl rubber, nitrile rubber and silicone rubber is conventionally used.

Since cross-linking treatment is performed under high temperature and high pressure at the time of manufacturing the shielded insulated electric cable 40 as described above, it is necessary to prevent the insulation layer 43 or the sheath 47 from adhering to the conductor 41 or the metal braid 45, and thus, plural separators are used for preventing the adhesion.

The related arts to the invention may be JP-A-63-128509 and JP-A-2008-84833.

### SUMMARY OF THE INVENTION

However, the shielded insulated electric cable as described above has a problem that flexibility is degraded since plural separator are included or that terminal processability is degraded since a portion of the separator is left at the time of terminal processing.

If separators are omitted to prevent the above-mentioned problem, an insulation layer or a sheath adheres to a conductor or a metal braid, which result in degradation of terminal processability. Specifically, the insulation layer enters into weave pattern of the metal braid, which makes folding work of the metal braid difficult.

A material good in peeling property from metal includes a fluoro-rubber. However, a halogen rubber including the fluoro-rubber may generate harmful gas when disposed by burning, etc.

On the other hand, a halogen-free rubber requires an addition of a large amount of halogen-free flame retardant, including magnesium hydroxide, in order to impart flame retardance, which may lead to deterioration of mechanical characteristics or thermal resistance.

In addition, a silicone rubber with good thermal resistance as a halogen-free rubber has low abrasion resistance and may also cause contact failure when being exposed to high temperature since low-molecular siloxane is volatilized and adheres to an electrical contact portion.

Therefore, it is an object of the invention to provide a shielded insulated electric cable with high thermal resistance in which adhesion between an insulation layer and a metal braid is prevented and folding work of the metal braid is easy.

(1) According to one embodiment of the invention, a shielded insulated electric cable comprises:

an insulation layer that is in contact with a metal braid,

wherein the insulation layer comprises a halogen-free cross-linked rubber that comprises 100 parts by weight of a halogen-free rubber excluding a silicone rubber, and 1 to 20 parts by weight of a hindered phenol compound and a thioether compound.

In the above embodiment (1) of the invention, the following modifications and changes can be made.

(i) An oxidation induction period of the insulation layer at 200° C. is not less than 10 minutes.

(ii) The insulation layer has a thickness of not less than 0.1 mm.

(2) According to another embodiment of the invention, a shielded insulated electric cable comprises:

a conductor;

an insulation layer on a periphery of the conductor; and

a shielding layer on a periphery of the insulation layer, the shielding layer contacting the insulation layer,

wherein the insulation layer comprises a halogen-free cross-linked rubber that comprises 100 parts by weight of a halogen-free rubber excluding a silicone rubber, and 1 to 20 parts by weight of a hindered phenol compound and a thioether compound.

In the above embodiment (2) of the invention, the following modifications and changes can be made.

(iii) No separator layer for separating the insulation layer and the shielding layer lies between the insulation layer and the shielding layer.

(iv) The halogen-free rubber has a rheometer torque of not less than 10 dN·m.

(v) The halogen-free rubber comprises one of ethylene-propylene-diene terpolymer rubber (EPDM) and hydrogenated acrylonitrile butadiene rubber (HNBR) having a rheometer torque of not less than 10 dN·m.

(vi) The hindered phenol compound comprises pentaerythritol tetrakis [3-(3,5-di-tert-butyl-4-hydroxyphenyl)propionate], and the thioether compound comprises pentaerythrityl tetrakis(3-lauryl thiopropionate).

### POINTS OF THE INVENTION

According to one embodiment of the invention, a shielded insulated electric cable is constructed such that an insulation layer formed directly contacting a shielding layer (e.g., a metal braid) between a center conductor and the shielding layer is formed of a halogen-free crosslinked rubber, in which 1 to 20 parts by weight of a hindered phenol compound and an thioether compound is included per 100 parts by weight of the halogen-free rubber having a rheometer torque of not less than 10 dN·m and excluding a silicone rubber. Therefore, the shielded insulated electric cable can have a high heat resistance as well as a good terminal processing property (or peeling property) such that the adhesion between the insulation layer and the shielding layer is prevented to facilitate the folding work of the shielding layer (i.e., metal braid) even when an intermediate separator as previously used for separating the insulation layer and the shielding layer is omitted.

### BRIEF DESCRIPTION OF THE DRAWINGS

Next, the present invention will be explained in more detail in conjunction with appended drawings, wherein:

FIG. 1 is a cross sectional view showing a shielded insulated electric cable of the present invention;

FIG. 2 is a diagram showing a relation between peeling strength and rheometer torque;

FIG. 3 is a diagram showing a relation between evaluation of thermal resistance and oxidation induction period; and

FIG. 4 is a cross sectional view showing a conventional shielded insulated electric cable.

### DETAILED DESCRIPTION OF THE PREFERRED EMBODIMENTS

A preferred embodiment of the invention will be described below in conjunction with the appended drawings.

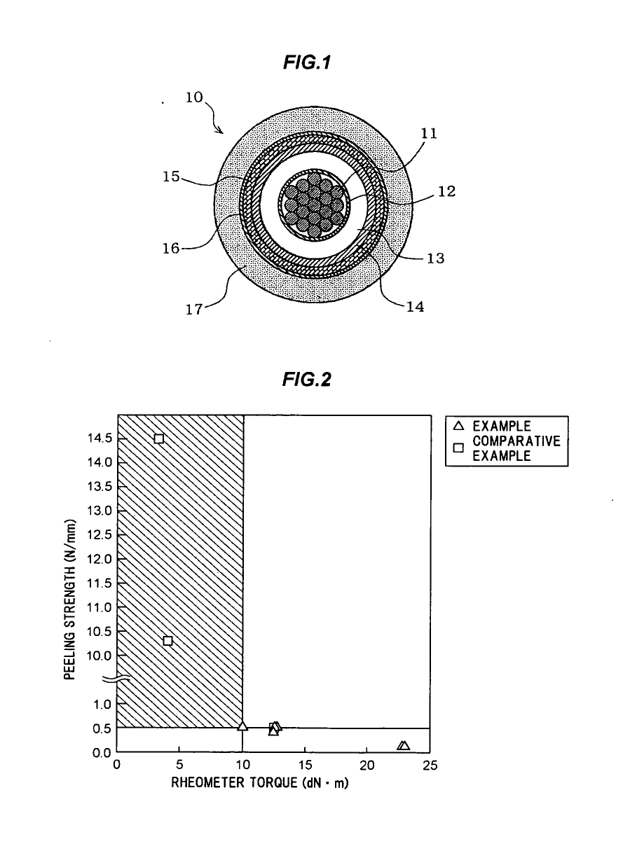

FIG. 1 is a cross sectional view showing a shielded insulated electric cable in a preferred embodiment of the invention.

As shown in FIG. 1, a shielded insulated electric cable 10 in the present embodiment is composed of an inner separator 12, an inner insulation layer 13, an outer insulation layer 14, a metal braid 15 (as a shielding layer), an outer separator 16 and a sheath 17 which are sequentially formed on a conductor 11, and an insulation layer (i.e., the outer insulation layer 14) is in contact with the metal braid 15.

It is preferable that tin plating, nickel plating, silver plating or gold plating, etc., be applied to surfaces of the conductor 11 and the metal braid 15. This allows improvement in thermal resistance.

Materials of the inner separator 12 and the outer separator 16 include resins such as nylon and polyester, or paper or fabric.

A material of the inner insulation layer 13 is not specifically limited, however, it is possible to improve thermal resistance when the inner insulation layer 13 is formed of the same material as the below-described outer insulation layer 14.

The shielded insulated electric cable 10 in the present embodiment is characterized in that the outer insulation layer 14 is formed of a halogen-free cross-linked rubber in which 1 to 20 parts by weight of an additive composed of a hindered phenol compound and an thioether compound is included per 100 parts by weight of halogen-free rubber other than a silicone rubber.

A halogen-free cross-linked rubber which is preferable for the outer insulation layer 14 will be described below.

Since temperature and pressure become high during cross-linking treatment of a cable sheath, if viscosity of the cross-linked insulation layer (i.e., the outer insulation layer 14) which is in contact with the metal braid 15 is low, the insulation layer enters into weave pattern of the metal braid 15 and folding work of the metal braid 15 becomes difficult. Here, a rheometer torque can be used as a viscosity index after cross-linking.

The folding work of the metal braid becomes difficult when a rheometer torque of the material of the outer insulation layer 14 is less than 10 dN·m. Therefore, it is preferable that the rheometer torque of the material of the outer insulation layer 14 be 10 dN·m or more, and this characteristic can be achieved by using a halogen-free rubber as a base.

A halogen-free rubber having the rheometer torque of 10 dN·m or more is defined as an elastic body that no endothermic peak upon crystal melting is observed by a differential scanning calorimeter.

A halogen-free rubber that may meet the above conditions includes, ethylene-propylene copolymer rubber (EPR), ethylene-propylene-diene terpolymer rubber (EPDM), acrylonitrile butadiene rubber (NBR), hydrogenated NBR(HNBR), acrylic rubber, ethylene-acrylic acid ester copolymer rubber, ethylene-octene copolymer rubber (EOR), ethylene-vinyl acetate copolymer rubber, ethylene-butene-1 copolymer rubber (EBR), styrene-butadiene copolymer rubber (SBR), isobutylene-isoprene copolymer rubber (IIR), block copolymer rubber which has a polystyrene block, urethane rubber and phosphazene rubber, etc., which may be used alone or in combination with two or more.

Note that, polyolefin of which crystal melting endothermic peak is observed generally has a low rheometer torque due to a molecular weight smaller than that of the halogen-free rubber and is difficult to have the rheometer torque of 10 dN·m or more, hence, unsuitable for the invention.

The hindered phenol compound added to the halogen-free rubber includes, e.g., pentaerythritol tetrakis [3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, N,N′-hexane-1,6-diyl bis[3-(3,5-di-tert-butyl-4-hydroxyphenyl)propionamide], benzenepropanoic acid, 3,5-bis(1,1-dimethylethyl)-4-hydroxy, C7-C9 side-chain-alkyl ester, 3,3′,3″,5,5′,5″-hexa-tert-butyl-a,a′,a″-(methylene-2,4,6-triyl)tri-p-cresol, 4,6-bis(octylthiomethyl)-o-cresol, 4,6-bis(dodecylthiomethyl)-o-cresol, ethylenebis(oxyethylene) bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trion, 1,3,5-tris[(4-tert-butyl-3-hydroxy-2,6-xylyl)methyl]-1,3,5-triazine-2,4,6(1H,3H,5H)-trione, 2,6-di-tert-butyl-4-(4,6-bis(octylthio)-1,3,5-triazin-2-ylamino) phenol, hindered phenol and hindered bis-phenol, etc.

Meanwhile, the thioether compound added to the halogen-free rubber includes, e.g., dilauryl 3,3′-thiodipropionate, dimyristyl 3,3′-thiodipropionate, distearyl 3,3′-thiodipropionate, pentaerythrityl tetrakis(3-lauryl thiopropionate), ditridecyl 3,3′-thiodipropionate, a sulfur-containing ester compound and 1,1′-thiobis(2-naphthol), etc.

The reason for adding 1 to 20 parts by weight of an additive composed of the hindered phenol compound and the thioether compound per 100 parts by weight of halogen-free rubber is to impart thermal resistance at a rated temperature of 120° C. That is, it is because it is not possible to obtain satisfactory thermal resistance unless the total used amount of the hindered phenol compound and the thioether compound is 1 part by weight or more while flame retardance degrades when more than 20 parts by weight.

It is especially preferable that the added amount of the hindered phenol compound be 0.1 to 19.9 parts by weight and that of the thioether compound be 0.1 to 19.9 parts by weight. The hindered phenol compound has an effect of trapping polymer radical and the thioether compound has an effect of decomposing polymer peroxide. A synergistic effect the two compounds is required in order to impart thermal resistance at a rated temperature of 120° C. An imidazole compound and a phosphorus compound are considered to impart thermal resistance but are factors which cause cross-linking inhibition.

From the above reason, it is most preferable that a halogen-free crosslinked rubber, in which 1 to 20 parts by weight of an additive composed of a hindered phenol compound and an thioether compound is included per 100 parts by weight of halogen-free rubber having a rheometer torque of 10 dN·m or more other than a silicone rubber, be used as a material of the outer insulation layer 14.

In addition, a cross-linking agent is not specified as long as the amount used is sufficient to promote cross-linking, and for example, 1 to 5 parts by weight of organic peroxide per 100 parts by weight of halogen-free rubber is preferable.

It is possible to further add a flame retardant in order to enhance flame retardance of the outer insulation layer 14. The flame retardant includes a metal hydroxide-based flame retardant such as magnesium hydroxide and aluminum hydroxide, a nitrogen-based flame retardant such as melamine cyanurate, a phosphorus-based flame retardant such as red phosphorus and phosphate ester, and a zinc-based flame retardant such as hydroxy zinc stannate and zinc borate, which may be used alone or in combination with two or more. Considering dispersibility of a flame retardant, surface treatment can be performed using a silane coupling agent, a titanate based coupling agent or fatty acid such as stearic acid, etc.

A cross-linking agent, a crosslinking aid, an ultraviolet absorber, a light stabilizer, a softener, a lubricant, a colorant, a reinforcing agent, a surface active agent, an inorganic filler, a coupling agent, a plasticizer, a metal chelator, a foaming agent, a compatibilizing agent, a processing aid and a stabilizer, etc., can be added to the outer insulation layer 14 which is composed of the above materials, as needed.

Meanwhile, an oxidation induction period of the outer insulation layer 14 at 200° C. is preferably 10 minutes or more, and it is preferable that the outer insulation layer 14 have a thickness of 0.1 mm or more. This is because it is not possible to obtain sufficient thermal resistance when the oxidation induction period of the outer insulation layer 14 at 200° C. is less than 10 minutes and it is not possible to ensure thermal resistance when the outer insulation layer 14 is less than 0.1 mm.

Chemical cross-linking such as organic peroxide, sulfur compound, amine compound and silane-grafted water-crosslinking, etc., and electron beam radiation crosslinking according to a conventional manner are applicable as the cross-linking treatment of the outer insulation layer 14.

According to the embodiment of the invention, it is possible to provide a shielded insulated electric cable with a high heat resistance and a reduced adhesion between an insulation layer and a metal braid to facilitate the folding work of the metal braid even when an intermediate separator is omitted.

Although, in the present embodiment, an insulation layer has a two-layer structure composed of the inner insulation layer 13 and the outer insulation layer 14 and a material of the outer insulation layer 14 is specified to achieve an object of the invention, it is possible to configure the insulation layer to have a single-layer structure in which a halogen-free crosslinked rubber which satisfies the conditions defined in the invention is used as a material of the insulation layer.

### EXAMPLES

A shielded insulated electric cable having a structure shown in FIG. 1 was made, and rheometer torque, adhesion, thermal resistance, oxidation induction period and flame retardance were evaluated.

Manufacturing of Shielded Insulated Electric Cable

A tin-plated copper strand was used for a conductor. A conductor size was 35 SQ, and the conductor configuration was as follows; number of twisted main wires/number of twisted sub-wires/strand diameter (mm)=19/35/0.26.

A 38 μm thick polyethylene terephthalate tape having a width of 25 mm as an inner separator was wound around the conductor with an overlap of ¼.

The compositions shown in Tables 1 and 2 were employed for inner and outer insulation layers. Coating of the inner and outer insulation layers was applied by a two layer extrusion using a 4.5-inch continuous steam crosslinking extruder so that the total thickness of the two layers was 1 mm. The crosslinking was performed for 5 minutes using high-pressure steam of 1.8 MPa.

A metal braid using a tin-plated copper strand having a strand diameter of 0.12 mm was formed on the insulation layer so as to be a braid coverage of 90% or more.

A 38 μm thick polyethylene terephthalate tape having a width of 25 mm was wound as an outer separator with an overlap of ¼.

Coating of a sheath having a composition shown in Tables 1 and 2 was applied using a 4.5-inch continuous steam crosslinking extruder in the same manner as for the insulation layer. The crosslinking was performed for 5 minutes using high-pressure steam of 1.8 MPa, thereby making a shielded insulated electric cable.

TABLE 1

| | Examples | | | | | | | |
|---|---|---|---|---|---|---|---|---|
| | Examples | | | | | | | |
| | Inner | | | | | | | |
| | insulation | | Outer insulation layer | | | | | |
| Items | layer | Sheath | 1 | 2 | 3 | 4 | 5 | 6 |
| EPDM¹⁾ | 100 | 100 | 100 | 100 | 100 | 100 | | |
| HNBR²⁾ | | | | | | | 100 | 100 |
| Magnesium hydroxide³⁾ | 100 | 100 | 100 | 100 | 100 | 100 | 100 | 100 |
| 1,3-bis(2-t-butylperoxyisopropyl)benzene⁴⁾ | 2 | 2 | 2 | 2 | 2 | 1.5 | 2 | 2 |
| Zinc oxide (Zinc Flower No. 3)⁵⁾ | 2 | 2 | 2 | 2 | 2 | 2 | 2 | 2 |
| Hindered phenol compound⁶⁾ | 0.5 | 0.5 | 0.5 | 19.9 | 0.1 | 0.5 | 0.5 | 10 |
| Thioether compound⁷⁾ | 0.5 | 0.5 | 0.5 | 0.1 | 19.9 | 0.5 | 0.5 | 10 |
| Oleic amide⁸⁾ | 1 | 1 | 1 | 1 | 1 | 1 | 1 | 1 |
| Thickness of outer insulation layer (mm) | | | 0.1 | 0.1 | 0.1 | 0.1 | 0.1 | 0.05 |
| Rheometer torque (dN · m) | | | 12.5 | 12.7 | 12.6 | 10 | 22.8 | 23 |
| Adhesion: peeling strength (N/mm) | | | 0.4 | 0.5 | 0.5 | 0.5 | 0.1 | 0.1 |
| Result | | | ◯ | ◯ | ◯ | ◯ | ◯ | ◯ |
| Thermal resistance | | | ◯ | ⊚ | ⊚ | ◯ | ◯ | ⊚ |
| Oxidation induction period (min) | | | 10 | 250 | 263 | 12 | 18 | 296 |
| Flame retardance | | | ◯ | ◯ | ◯ | ◯ | ◯ | ◯ |
| Comprehensive evaluation | | | ◯ | ⊚ | ◯ | ⊚ | ◯ | ⊚ |

Unit of blending amount is parts by weight.
¹⁾EPT 1045 manufactured by Mitsui Chemicals Inc.,
²⁾Zetpol 2010L manufactured by Zeon Corporation,
³⁾Kisuma 5L manufactured by Kyowa Chemical Industry Co., Ltd.,
⁴⁾Perkadox 14 manufactured by Kayaku Akzo Corporation,
⁵⁾Zinc Flower No. 3 manufactured by Sakai Chemical Industry Co., Ltd.,
⁶⁾IRGANOX 1010 manufactured by Ciba Japan K.K.,
⁷⁾Seenox 412S manufactured by Shipro Kasei Kaisha Ltd.,
⁸⁾DIAMIDO-200 manufactured by Nippon Kasei Chemical Co., Ltd.

TABLE 2

| | Examples | | | | | |
|---|---|---|---|---|---|---|
| | Comparative Examples | | | | | |
| | Inner | | | | | |
| | insulation | | Outer insulation layer | | | |
| Items | layer | Sheath | 1 | 2 | 3 | 4 |
| EPDM | 100 | 100 | | | 100 | 100 |
| Ethylene ethyl acrylate copolymer⁹⁾ | | | 100 | | | |
| Polyethylene¹⁰⁾ | | | | 100 | | |
| Magnesium hydroxide | 100 | 100 | 100 | 100 | 100 | 100 |
| 1,3-bis(2-t-butylperoxyisopropyl)benzene | 2 | 2 | 2 | 2 | 2 | 2 |
| Zinc oxide (Zinc Flower No. 3) | 2 | 2 | 2 | 2 | 2 | 2 |
| Hindered phenol compound | 0.5 | 0.5 | 0.5 | 0.5 | 0.4 | 11 |
| Thioether compound | 0.5 | 0.5 | 0.5 | 0.5 | 0.5 | 10 |
| Oleic amide | 1 | 1 | 1 | 1 | 1 | 1 |
| Thickness of outer insulation layer (mm) | | | 0.1 | 0.1 | 0.1 | 0.1 |
| Rheometer torque (dN · m) | | | 4.1 | 3.3 | 12.5 | 12.5 |
| Adhesion: peeling strength (N/mm) | | | 10.3 | 14.5 | 0.4 | 0.4 |
| Result | | | X | X | ◯ | ◯ |
| Thermal resistance | | | ◯ | ◯ | X | ⊚ |
| Oxidation induction period (min) | | | 11 | 13 | 9 | 275 |
| Flame retardance | | | ◯ | ◯ | ◯ | X |
| Comprehensive evaluation | | | X | X | X | X |

Unit of blending amount is parts by weight.
⁹⁾MFR = 0.4 g/10 min, ethyl acrylate content = 10 mass %
¹⁰⁾MFR = 0.2 g/10 min, density = 924 kg/m³

Characteristic Evaluation

For evaluating the rheometer torque, the maximum torque value in 10 minutes was measured at a test temperature of 192° C. in accordance with JIS K6300.

For evaluating the adhesion between the outer insulation layer and the metal braid, the outer insulation layer and the metal braid, which were still in contact with each other, were cut into 12.5 mm wide and the peeling strength was measured by a T-peel test at a tension rate of 50 mm/min. Since folding work of the metal braid is easy when the peeling strength is 0.5 N/mm or less, the peeling strength of 0.5 N/mm or less was evaluated as “passed (indicated by ∘)” and more than 0.5 N/mm was evaluated as “failed (indicated by X)”.

For evaluating the thermal resistance, the shielded insulated electric cable was cut into 450 mm, was heat-treated at 120° C. for 10,000 hours and was subsequently wound one turn around a □ 45 mm (diameter) mandrel, and then, a sheath, an outer separator and a metal braid were removed to observed the outer insulation layer. It was evaluated as bad (X) when the outer layer was cracked and as good (∘) without cracks.

Further, the cable without cracks was rewound one turn around a □ 9 mm (diameter) mandrel and was evaluated as excellent (⊚) when there was no crack. Good (∘) and excellent (⊚) were evaluated as “passed” and bad (X) was evaluated as “failed”.

For evaluating the oxidation induction period, the sheath, the outer separator and the metal braid were removed, 5 mg of outer insulation layer was taken, and time until initiation of heat generation in a 200° C. environment was measured by using a differential scanning calorimeter. It was evaluated as “passed” when the exothermic reaction started after 10 minutes or more, and as “failed” when the reaction started earlier than 10 minutes.

The flame retardance was evaluated in accordance with ISO6722 and it was evaluated as “good (∘)” when self-extinguished within 70 seconds, and as “bad (X)” when the burning continued for more than 70 seconds.

As a comprehensive evaluation, the cable evaluated as excellent (⊚) in the thermal resistance as well as excellent (⊚) in the other evaluations was evaluated as excellent (⊚), the cable evaluated as good (∘) in the thermal resistance as well as good (∘) in the other evaluations was evaluated as good (∘), and the cable which failed any of the evaluations was evaluated as bad (X).

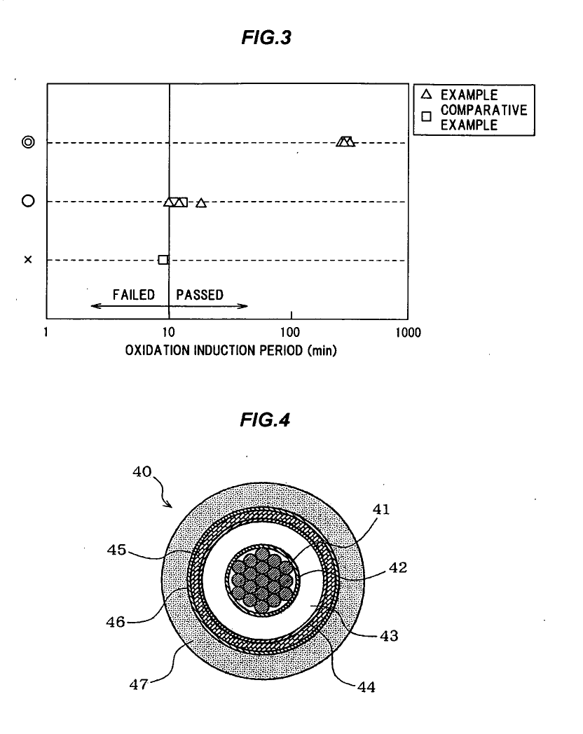

Meanwhile, a relation between the peeling strength and the rheometer torque shown in Examples and Comparative Examples is shown in FIG. 2 and a relation between the evaluation of thermal resistance and the oxidation induction period is shown in FIG. 3. From these figures, it is understood that it is possible to solve the problem when the values of the rheometer torque and the oxidation induction period are within the specified range. Examples will be described in detail below.

### Examples 1 to 4

Compounds including EPT 1045 (manufactured by Mitsui Chemicals Inc.) as EPDM, magnesium hydroxide (Kisuma 5L manufactured by Kyowa Chemical Industry Co., Ltd.) as a flame retardant, 1,3-bis(2-t-butylperoxyisopropyl)benzene (Perkadox 14 manufactured by Kayaku Akzo Corporation) as an organic peroxide, Zinc Flower No. 3 (manufactured by Sakai Chemical Industry Co., Ltd.) as a crosslinking aid, pentaerythritol tetrakis [3-(3,5-di-tert-butyl-4-hydroxyphenyl)propionate] (IRGANOX 1010 manufactured by Ciba Japan K.K.) as a hindered phenol compound, pentaerythrityl tetrakis(3-lauryl thiopropionate) (Seenox 412S manufactured by Shipro Kasei Kaisha Ltd.) as a thioether compound and oleic amide as a lubricant at compounding ratios shown in Table 1 were made by using a 55 L kneader to form inner and outer insulation layers and a sheath. The compounds obtained were extruded to form a shielded insulated electric cable shown in FIG. 1.

The results are shown in Table 1. The comprehensive evaluation is excellent (⊚) or good (∘) since satisfactory results were obtained in each evaluation.

### Examples 5 and 6

A compound was made to form an inner insulation layer and a sheath in the same manner as Examples 1 to 4. A compound including Zetpol 2010L (manufactured by Zeon Corporation) as HNBR, magnesium hydroxide (Kisuma 5L manufactured by Kyowa Chemical Industry Co., Ltd.) as a flame retardant, 1,3-bis(2-t-butylperoxyisopropyl)benzene (Perkadox 14 manufactured by Kayaku Akzo Corporation) as an organic peroxide, Zinc Flower No. 3 (manufactured by Sakai Chemical Industry Co., Ltd.) as a crosslinking aid, pentaerythritol tetrakis [3-(3,5-di-tert-butyl-4-hydroxyphenyl)propionate] (IRGANOX 1010 manufactured by Ciba Japan K.K.) as a hindered phenol compound, pentaerythrityl tetrakis(3-lauryl thiopropionate) (Seenox 412S manufactured by Shipro Kasei Kaisha Ltd.) as a thioether compound and oleic amide as a lubricant at compounding ratios shown in Table 1 was made by using a 55 L kneader to form an outer insulation layer. The compounds obtained were extruded to form a shielded insulated electric cable shown in FIG. 1. The results are shown in Table 1. The comprehensive evaluation is excellent (⊚) or good (∘) since satisfactory results were obtained in each evaluation.

### Comparative Example 1

A compound including 100 parts by weight of EPDM, 100 parts by weight of magnesium hydroxide, 2 parts by weight of 1,3-bis(2-t-butylperoxyisopropyl)benzene, 2 parts by weight of Zinc Flower No. 3, 0.5 parts by weight of pentaerythritol tetrakis [3-(3,5-di-tert-butyl-4-hydroxyphenyl)propionate], 0.5 parts by weight of pentaerythrityl tetrakis(3-lauryl thiopropionate) and 1 part by weight of oleic amide was made to form an inner insulation layer and a sheath. A compound including 100 parts by weight of ethylene ethyl acrylate copolymer (MFR: 0.4 g/10 min, ethyl acrylate content: 10 mass %), 100 parts by weight of magnesium hydroxide, 2 parts by weight of 1,3-bis(2-t-butylperoxyisopropyl)benzene, 2 parts by weight of Zinc Flower No. 3, 0.5 parts by weight of pentaerythritol tetrakis [3-(3,5-di-tert-butyl-4-hydroxyphenyl)propionate], 0.5 parts by weight of pentaerythrityl tetrakis(3-lauryl thiopropionate) and 1 part by weight of oleic amide was made to form an outer insulation layer. The compounds obtained were extruded to form a shielded insulated electric cable shown in FIG. 1.

The results are shown in Table 2. The thermal resistance and the flame retardance were satisfactory, however, the rheometer torque was 4.1 dN·m. It is judged that folding work of the metal braid is difficult since the outer insulation layer enters into metal braid and the peeling strength is 0.5 N/mm or more, and thus, the comprehensive evaluation is bad (X).

### Comparative Example 2

A compound was made to form an inner insulation layer and a sheath in the same manner as Comparative Example 1. A compound including 100 parts by weight of polyethylene (density: 924 kg/m³, MFR: 0.2 g/10 min), 100 parts by weight of magnesium hydroxide, 2 parts by weight of 1,3-bis(2-t-butylperoxyisopropyl)benzene, 2 parts by weight of Zinc Flower No. 3, 0.5 parts by weight of pentaerythritol tetrakis [3-(3,5-di-tert-butyl-4-hydroxyphenyl)propionate], 0.5 parts by weight of pentaerythrityl tetrakis(3-lauryl thiopropionate) and 1 part by weight of oleic amide was made to form an outer insulation layer. The compounds obtained were extruded to form a shielded insulated electric cable shown in FIG. 1.

The results are shown in Table 2. The thermal resistance and the flame retardance were satisfactory, however, the rheometer torque was 3.3 dN·m. It is judged that folding work of the metal braid is difficult since the outer insulation layer enters into metal braid and the peeling strength is 0.5 N/mm or more, and thus, the comprehensive evaluation is bad (X).

### Comparative Example 3

A compound was made to form an inner insulation layer and a sheath in the same manner as Comparative Example 1. A compound including 100 parts by weight of EPDM, 100 parts by weight of magnesium hydroxide, 2 parts by weight of 1,3-bis(2-t-butylperoxyisopropyl)benzene, 2 parts by weight of Zinc Flower No. 3, 0.4 parts by weight of pentaerythritol tetrakis [3-(3,5-di-tert-butyl-4-hydroxyphenyl)propionate], 0.5 parts by weight of pentaerythrityl tetrakis(3-lauryl thiopropionate) and 1 part by weight of oleic amide was made to form an outer insulation layer. The compounds obtained were extruded to form a shielded insulated electric cable shown in FIG. 1.

The results are shown in Table 2. The adhesion and the flame retardance were satisfactory, however, the oxidation induction period was 9 minutes and cracks were generated, and thus, the comprehensive evaluation is bad (X).

### Comparative Example 4

A compound was made to form an inner insulation layer and a sheath in the same manner as Comparative Example 1. A compound including 100 parts by weight of EPDM, 100 parts by weight of magnesium hydroxide, 2 parts by weight of 1,3-bis(2-t-butylperoxyisopropyl)benzene, 2 parts by weight of Zinc Flower No. 3, 11 parts by weight of pentaerythritol tetrakis [3-(3,5-di-tert-butyl-4-hydroxyphenyl)propionate], 10 parts by weight of pentaerythrityl tetrakis(3-lauryl thiopropionate) and 1 part by weight of oleic amide was made to form an outer insulation layer. The compounds obtained were extruded to form a shielded insulated electric cable shown in FIG. 1.

The results are shown in Table 2. The adhesion and the thermal resistance were satisfactory, however, the burning continued for more than 70 seconds in the flame retardant test, and thus, the comprehensive evaluation is bad (X). From the above, it is understood that, according to the present invention, it is possible to obtain a shielded insulated electric cable with high thermal resistance in which adhesion between an insulation layer and a metal braid is prevented and folding work of the metal braid is easy.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A shielded insulated electric cable, comprising:
an insulation layer that is in contact with a metal braid,
wherein the insulation layer comprises a halogen-free cross-linked rubber that comprises 100 parts by weight of a halogen-free rubber excluding a silicone rubber, and 1 to 20 parts by weight of a hindered phenol compound and a thioether compound.

2. The shielded insulated electric cable according to claim 1, wherein an oxidation induction period of the insulation layer at 200° C. is not less than 10 minutes.

3. The shielded insulated electric cable according to claim 1, wherein the insulation layer has a thickness of not less than 0.1 mm.

4. A shielded insulated electric cable, comprising:
a conductor;
an insulation layer on a periphery of the conductor; and
a shielding layer on a periphery of the insulation layer, the shielding layer contacting the insulation layer,
wherein the insulation layer comprises a halogen-free cross-linked rubber that comprises 100 parts by weight of a halogen-free rubber excluding a silicone rubber, and 1 to 20 parts by weight of a hindered phenol compound and a thioether compound.

5. The shielded insulated electric cable according to claim 4, wherein no separator layer for separating the insulation layer and the shielding layer lies between the insulation layer and the shielding layer.

6. The shielded insulated electric cable according to claim 4, wherein the halogen-free rubber has a rheometer torque of not less than 10 dN·m.

7. The shielded insulated electric cable according to claim 4, wherein the halogen-free rubber comprises one of ethylene-propylene-diene terpolymer rubber (EPDM) and hydrogenated acrylonitrile butadiene rubber (HNBR) having a rheometer torque of not less than 10 dN·m.

8. The shielded insulated electric cable according to claim 4, wherein the hindered phenol compound comprises pentaerythritol tetrakis [3-(3,5-di-tert-butyl-4-hydroxyphenyl)propionate], and the thioether compound comprises pentaerythrityl tetrakis(3-lauryl thiopropionate).
